(19) United States
(12) Patent Application Publication
(10) Pub. No.: US 2021/0317837 A1
(43) Pub. Date: Oct. 14, 2021

(54) CENTRIFUGAL COMPRESSOR AND METHOD OF OPERATING THE SAME

(71) Applicant: Carrier Corporation, Palm Beach Gardens, FL (US)

(72) Inventors: Jun Cao, Shanghai (CN); Vishnu M. Sishtla, Syracuse, NY (US); Sheng Chen, Shanghai (CN); Hao Zhao, Shanghai (CN)

(21) Appl. No.: 17/122,138

(22) Filed: Dec. 15, 2020

(30) Foreign Application Priority Data
Apr. 10, 2020 (CN) 202010278621.1

(51) Int. Cl. F04D 27/00; F04D 25/06

(52) U.S. Cl. CPC F04D 27/00; F04D 25/06

(57) ABSTRACT

The invention relates to a centrifugal compressor and a method of operating the same. A centrifugal compressor of the invention includes an impeller, a diffuser and a variable diffusion system, wherein the diffuser is disposed downstream of the impeller and has a respective diffuser frame that defines at least a channel through which the fluid flows from the impeller; moreover, the variable diffusion system comprises a movable body that is able to move relative to the channel and an electromagnetic actuating device, and the electromagnetic actuating device controls the movable body to move relative to the channel in an electromagnetic driving manner. The variable diffusion system of the centrifugal compressor in the invention is simple in implementation structure, low in cost, easy to operate and good in stability and reliability.

### CROSS-REFERENCE TO RELATED APPLICATIONS

This application claims priority to Chinese Patent Application No. 202010278621.1, filed Apr. 10, 2020, the contents of which are incorporated by reference herein in their entirety.

### BACKGROUND

The invention pertains to the technical field of compressors, relates to a centrifugal compressor with a variable diffusion system and a method of operating the centrifugal compressor, and further relates to a heat exchanger system using the centrifugal compressor.

Heat exchanger system often employs a centrifugal compressor to compress fluids as part of a vapor-compression cycle. The centrifugal compressor includes diffusers through which compressed fluid flows. Such centrifugal compressor diffusers exhibit certain issues under various operational loads. For example, a centrifugal compressor diffuser can be noisy and have high vibration moments when part-load conditions are in effect. On the other hand, when full-load conditions are in effect, centrifugal compressor diffusers may be relatively inefficient due to having a narrow working envelope. In addition, centrifugal compressors and their drive systems can be complex.

### SUMMARY

According to an aspect of the disclosure, centrifugal compressors are provided. The centrifugal compressors include an impeller for sucking a fluid to be compressed, a diffuser disposed downstream of the impeller and having a respective diffuser frame, wherein the diffuser frame defines at least a channel through which the fluid flows from the impeller, and a variable diffusion system. The variable diffusion system includes a movable body that is able to move relative to the channel and an electromagnetic actuating device for controlling the movable body to move relative to the channel in an electromagnetic driving manner.

In accordance with an additional or alternative embodiment, the electromagnetic actuating device includes an electromagnetic driving execution assembly for generating a controllable magnetic field to drive the movable body to move towards a target position at least partially blocking the channel, a displacement transducer for sensing position information of the movable body relative to the channel, and a controller. The position information is sensed and fed back to the controller by the displacement transducer, and the controller is configured for controlling an electric signal applied to the electromagnetic driving execution assembly at least on the basis of the position information.

In accordance with an additional or alternative embodiment, the electromagnetic actuating device further includes a power amplifier for amplifying the control signal output by the controller so as to output the electric signal applied to the electromagnetic driving execution assembly.

In accordance with an additional or alternative embodiment, the electromagnetic driving execution assembly includes a first electromagnetic driving execution assembly and a second electromagnetic driving execution assembly, and the first electromagnetic driving execution assembly and the second electromagnetic driving execution assembly are oppositely disposed on both sides of the movable body, respectively. The controller controls, at least based on the position information, a first electric signal applied to the first electromagnetic driving execution assembly and a second electric signal applied to the second electromagnetic driving execution assembly, respectively, so as to enable the movable body to tend to move to the target position.

In accordance with an additional or alternative embodiment, the variable diffusion system further includes a resilient member, and the resilient member and the electromagnetic driving execution assembly are oppositely disposed on both sides of the movable body, respectively and wherein one end of the resilient member acts on the movable body and applies an elastic force to the movable body, and the controller, at least based on the position information, controls the electric signal applied to the electromagnetic driving execution assembly to enable the movable body to overcome the elastic force and tend to move to the target position.

In accordance with an additional or alternative embodiment, the controller is further configured to, based on the position information, determine that movable body has been in the target position and control the electrical signal applied to the electromagnetic driving execution assembly to stabilize the movable body in the target position.

In accordance with additional or alternative embodiments, the target position is determined by the controller in accordance with a load condition of the centrifugal compressor.

In accordance with additional or alternative embodiments, the movable body includes an annular magnetic member.

In accordance with additional or alternative embodiments, the electromagnetic actuating device controls the movable body to move steplessly or stepwise relative to the channel in the electromagnetic driving manner to cause the diffuser to provide a steplessly or stepwise variable diffusion capacity.

According to another aspect of the disclosure, methods of operating centrifugal compressors are provided. The methods include determining a load condition of the centrifugal compressor, determining a target position of the movable body in the channel according to the load condition, and controlling a force applied to the movable body by the electromagnetic actuating device by controlling electrical signal applied to the electromagnetic actuating device such that the movable body moves towards the target position. The target position is a position that at least partially blocks the channel.

The above features, operations and advantages of the present invention will become more obvious from the following descriptions and drawings. The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings, wherein the same or similar elements are denoted by the same reference sign, in which:

FIG. 1 is a schematic view of a partial cross-sectional structure of a centrifugal compressor according to an embodiment of the present invention.

FIG. 2 is a basic structural schematic view of an electromagnetic actuating device arranged in the centrifugal compressor of the embodiment shown in FIG. 1.

FIG. 3 is a schematic view of a partial cross-sectional structure of a centrifugal compressor according to another embodiment of the present invention.

FIG. 4 is a basic structural schematic view of an electromagnetic actuating device arranged in the centrifugal compressor of the embodiment shown in FIG. 3.

FIG. 5 is a flow chart of a method of operation of the centrifugal compressor according to an embodiment of the present invention.

### DETAILED DESCRIPTION

Orientation terms, such as up, down, left, right, front, back, etc., mentioned or may be mentioned in this specification are defined with respect to the configuration shown in the various drawings, which are relative concepts and, therefore, may vary accordingly depending on the different positions and different states of use in which they are located. Neither should these or other orientation terms be construed as limiting terms.

As will be described below, a centrifugal compressor with variable diffusion function is provided in the following embodiments, which is configured to control a movable body in a diffusion channel to move relative to the diffusion channel by means of an electromagnetic driving manner, so as to provide a variable diffusion capacity.

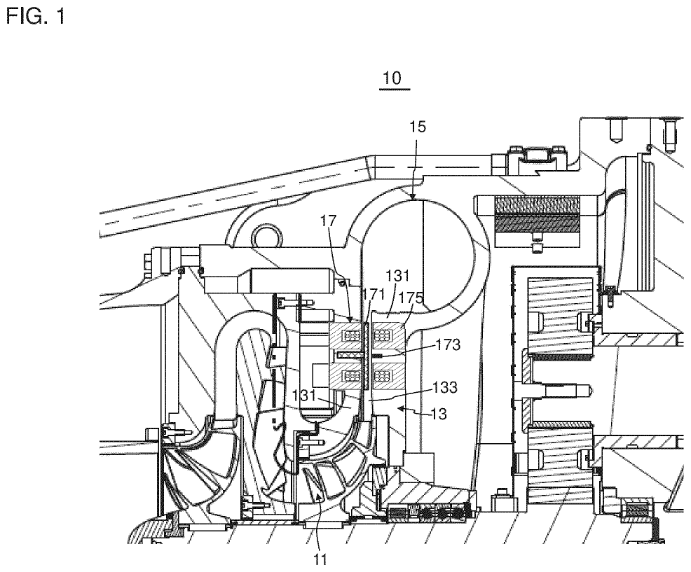

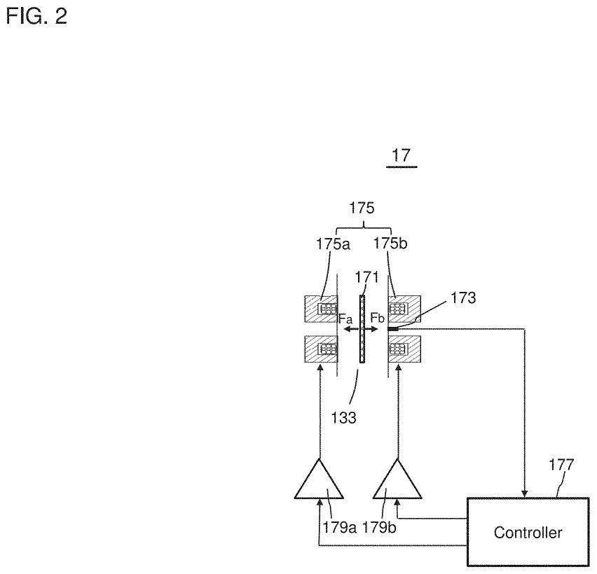

With reference to FIGS. 1 and 2, the centrifugal compressor 10 can rotate around its transverse axis, thus compressing fluid. The compressor 10 includes an impeller 11 that can be used to suck the fluid (e.g., refrigerant gas, etc.) to be compressed. The centrifugal compressor 10 may further include a diffuser 13 and a volute 15. The diffuser 13 is located between the impeller 11 and the volute 15. The volute 15 is arranged on radially outward sides with respect to the impeller 11 and is an area for collecting the compressed and expanded fluid. The impeller 11 rotates around the transverse axis of the compressor 10 to suck the fluid into the compressor. After the fluid leaves out the impeller 11, it passes through the diffuser 13 and then enters into the volute 15; wherein the diffuser 13 converts the kinetic energy (i.e., high velocity) of the fluid flowing there through into pressure by gradually slowing or diffusing the fluid velocity so that the compressed fluid can be pressurized. The compressed fluid may be further pressurized within the volute 15. The diffuser 13 may be vaneless, vaned or an alternating combination thereof

In particular, the diffuser 13 has a respective diffuser frame 131 within or adjacent to which the impeller 11 is rotatably disposed. The diffuser frame 131 can be configured to define, for example, a channel 133 through which the compressed fluid can flow from the impeller 11 and into the volute 15. The channel 133 may be understood as a type of diffusion channel, as shown in FIG. 1, which can be annular and extends along the transverse axis of the compressor 10 and outwardly in a radial direction from an outward-most extent of the impeller 11. It will be understood that the specific structure of the channel 133 is not limited to the examples in the figures.

With continued reference to FIGS. 1 and 2, a variable diffusion system 17 is also provided in the centrifugal compressor 10. The variable diffusion system 17 is arranged corresponding to the diffuser 13 such that the diffuser 13 has a variable diffusion capacity. For example, the diffusivity of the diffuser 13 is adjusted as a function of the load condition of the compressor 10.

Referring to FIG. 2, the variable diffusion system 17 includes a movable body 171 arranged corresponding to the channel 133, and further includes an electromagnetic actuating device disposed corresponding to the movable body 171. The electromagnetic actuating device controls movement of the movable body 171 relative to the channel 133 in an electromagnetic driving manner that differs from, for example, a piston-type driving manner of the movable bodies in the prior art, such that the diffuser 13 can provide variable diffusion capacity.

In an embodiment, the electromagnetic actuating device primarily includes a displacement transducer 173, an electromagnetic driving execution assembly 175, and a controller 177. The electromagnetic driving execution assembly 175 is used to generate a controllable magnetic field for driving the movable body 171 to move towards a target position. The target position may be a position that at least partially blocks the channel 133, that is, the movable body 171 is capable of partially blocking fluid flowing in the channel 133 when the movable body 171 is in the target position in the channel 133. A relatively reasonable target position may be calculated in accordance with the current load condition of the compressor 10 from the purpose of, for example, reducing noise and/or vibration.

More specifically, the electromagnetic driving execution assembly 175 can be formed by, for example, lamination stacks and insulated coils; and the movable body 171 can be formed by, for example, a magnetic material. The movable body 171 can be mounted on the diffuser frame 131 (as shown in FIG. 1) alongside the channel 133 but movable relative to the diffuser frame 131 under, for example, magnetic field forces generated by the electromagnetic driving execution assembly 175. The movable body 171 may include an annular member, and the annular member may be, for example, a magnetic diffusion ring, which may protrude into the channel 133 and be moved in the channel 133 to adjust the degree of obstruction to the fluid. It will be appreciated that, in case the variable diffuser system 17 is inactive, the movable body 171 (e.g., head of the movable body 171) may retract into wall of, for example, the diffuser frame 131 so that the movable body 171 does not create obstruction effect on the fluid flowing through the channel 133 (this condition is not shown in the figures). The electromagnetic driving execution assemblies 175 may include a first electromagnetic driving execution assembly 175a and a second electromagnetic driving execution assembly 175b. The first electromagnetic driving execution assembly 175a and the second electromagnetic driving execution assembly 175b may be oppositely disposed on both sides of the movable body 171, respectively. For example, they are fixed in the diffuser frame 131 on both sides of the movable body 171.

With continued reference to FIGS. 1 and 2, the displacement transducer 173 is arranged corresponding to the movable body 171 and is used to sense position information of the movable body 171 relative to the channel 133. Particularly, when the position of the movable body 171 changes, the displacement transducer 173 can acquire position information reflecting a change in position of the movable body 171 in real time. The displacement transducer 173 may specifically be an inductance-type displacement transducer or a current-vortex type displacement transducer, which may be fixedly mounted on the diffuser frame 131 on one side of the movable body 171 and face towards the movable body 171.

Referring to FIG. 2, the controller 177 is a core control component of the electromagnetic actuating device, that is coupled not only with the displacement transducer 173, but also with the electromagnetic driving execution assembly 175. The position information acquired by the displacement transducer 173 can be fed back to the controller 177 in real time, thereby forming a closed-loop control circuit. The controller 177 is configured to control an electrical signal (e.g., a current signal) applied to the electromagnetic driving execution assembly 175 based on at least the position information, so that the magnetic field force F generated to the movable body 171 can be accurately controlled, thereby accurately controlling the movement of the movable body 171. In the embodiment shown in FIG. 2, the controller 177 controls a first electrical signal applied to the first electromagnetic driving execution assembly 175a and a second electrical signal applied to the second electromagnetic driving execution assembly 175b, respectively, at least on the basis of the position information, to cause the movable body 171 to tend to move to the target position in the channel 171, thereby causing the diffuser 13 to provide a predetermined diffusion capacity.

By way of example, by controlling the first electrical signal and the second electrical signal described above, the magnetic field intensities generated by the first electromagnetic driving execution assembly 175a and the second electromagnetic driving execution assembly 175b, respectively, can be controlled and therefore, the magnetic field force Fₐ generated by the first electromagnetic driving execution assembly 175a for the movable body 171 is controlled, and the magnetic field force F_{b} generated by the second electromagnetic driving execution assembly 175b for the movable body 171 is controlled. If from the position information obtained from the feedback, it can be determined that the movable body 171 is in the target position, the first electric signal and the second electric signal will be controlled to enable the magnetic field force Fₐ to be equal to the magnetic field force F_{b}, so as to make the movable body 171 to be held in the current target position until the target position is changed. If the movable body 171 deviates to the left with respect to the target position as seen from the position information obtained by feedback, the first electric signal and the second electric signal will be controlled such that the magnetic field force F_{b} is greater than the magnetic field force Fₐ, and if the movable body 171 deviates to the right with respect to the target position as seen from the position information obtained by feedback, the first electric signal and the second electric signal will be controlled such that the magnetic field force Fₐ is greater than the magnetic field force F_{b}, until the movable body 171 is in the target position, thus a stable state is reached. Therefore, the movable body 171 can be stably and reliably moved to a certain target position in the channel 133 by the electromagnetic actuating device, and the control operation is simple.

It should be noted that, when the movable body 171 is already in the target position, the controller 177 can determine from the feedback position information that the movable body 171 is already in the target position. Before an updating change of the target position occurs, in an embodiment, a first electrical signal applied to the first electromagnetic driving execution assembly 175a and a second electrical signal applied to the second electromagnetic driving execution assembly 175b may be controlled by the controller 177 to cause the magnetic field force F_{b} to be equal to the magnetic field force Fₐ, thereby stabilizing the movable body 177 in the target position; in another alternative embodiment, the movable body 171 in the target position may also be fixed in the target position by means of mechanical limiting. As such, the movable body 171 can also be reliably fixed in a certain target position in the channel 133, facilitating to accurate and stable provision of a desired diffuser capacity.

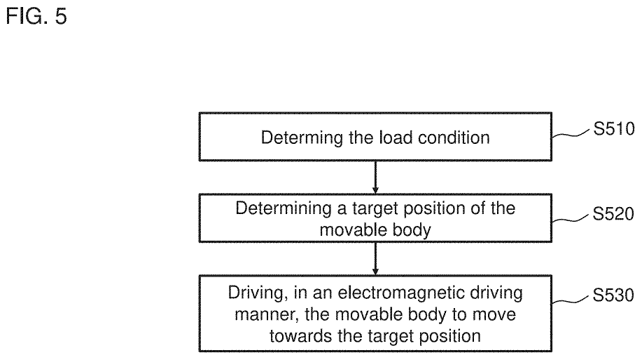

The controller 177 may specifically include an arithmetic logic unit (ALU), a floating point unit (FPU), a digital signal processing (DSP), a programmable controller, or any combination thereof, which may be pre-programmed to implement, for example, the method of the embodiment shown in FIG. 5. In an embodiment, the controller 177 may be further configured to analyze and obtain information of a state in which the variable diffusion system 17 is currently located according to the positional information, such as a state of the movable body 171, a corresponding diffusion capability, etc.; the controller 177 may transmit or share this information of state to other control components of the centrifugal compressor 10.

In an embodiment, the electromagnetic actuating device may further comprise a power amplifier 179, e.g. a first power amplifier 179a and a second power amplifier 179b provided corresponding to the first electromagnetic driving execution assembly 175a and the second electromagnetic driving execution assembly 175b, respectively. The first power amplifier 179a amplifies the control signal (e.g., a control current on the order of mA) output by the controller 177 for the first electromagnetic driving execution assembly 175a to output a first electrical signal (e.g., a drive current on the order of amps) applied on the first electromagnetic driving execution assembly 175a, the second power amplifier 179b amplifies the control signal (e.g., a control current on the order of mA) output by the controller 177 for the second electromagnetic driving execution assembly 175b to output a second electrical signal (e.g., a drive current on the order of amps) applied on the second electromagnetic driving execution assembly 175b.

It should be noted that the target position calculated by the above exemplary controller 177 can vary dynamically according to changes in the load conditions. In an embodiment, the target position can vary continuously. Correspondingly, the electromagnetic actuating device controls the movable body 171 to move steplessly or continuously relative to the channel 133 in the electromagnetic driving mode so as to cause the diffuser 13 to provide steplessly variable diffusion capacity; thus, the diffusion capacity of the diffuser 13 can be accurately adjusted and changed in accordance with the working condition of the compressor 10. In another embodiment, the target position can vary discontinuously, for example, the target position may include a plurality of pre-specified dispersed positions. Correspondingly, the electromagnetic actuating device controls the movable body 171 to move stepwise relative to the channel 133 in the electromagnetic driving mode so as to cause the diffuser 13 to provide stepwise variable diffusion capacity; thus, the control of the diffusion capacity of the diffuser 13 is relatively simple.

In particular, the controller 177 and the power amplifier 179 shown in FIG. 2 may be arranged in a circuit board (not shown in FIG. 1) whose mounting position inside the compressor 10 is unlimited. The variable diffusion system 17 also has a power source for powering the various components. For example, the power source may provide a low voltage power source to power the controller 177 and the power amplifier 179, and the power source may provide a relatively high voltage power source to power the electromagnetic driving execution assembly 175 (e.g., coils).

Since the variable diffusion system 17 of the above embodiments drives the movable body 171 in the channel 133 in an electromagnetic driving mode, compared with the scheme that a gas or oil actuator is used for driving the movable body to move in the channel 133 in a piston mode in the prior art, its overall structure becomes more simple, and it has smaller number of parts, lower cost, and is easier to design and assemble in relation to the diffuser in the compressor; meanwhile, the movement of the movable body 171 is easier to control, more accurate and more stable, and the corresponding diffusion capacity thereby can be realized more accurately and controllably. Moreover, since the structure is simplified, the movable body 171 is less restricted by the movable space, and it is also easier to move the movable body 171 in a larger route range, and thus the diffuser provides a larger variation range of the diffusion capacity.

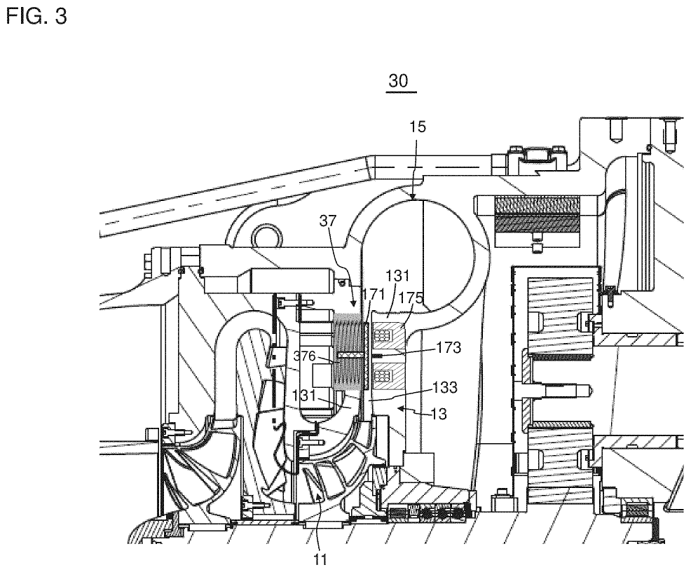

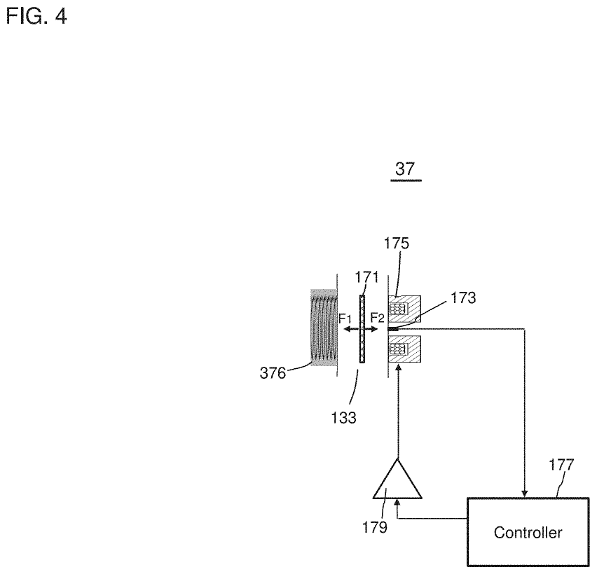

FIG. 3 shows another embodiment of the centrifugal compressor 30 in which the variable diffusion system 37 of the embodiment shown in FIG. 4 is used. The main difference of the compressor 30 relative to the embodiment shown in FIG. 1 lies in that the variable diffusion system 37 uses a resilient member 376 (e.g., springs, etc.). Specifically, the resilient member 376 and the electromagnetic driving execution assembly 175 are oppositely disposed on both sides of the movable body 171, respectively; wherein one end of the elastic part 376 acts on the movable body 171 and applies an elastic force F1 to the movable body 171, and the controller 177, at least based on the position information fed back by the transducer 173, controls the electric signal applied to the electromagnetic driving execution assembly, thereby controlling a magnetic field force F2 applied to the movable body 171 by the electromagnetic driving execution assembly 175, which causes the movable body 171 to tend to move in a certain target position in the channel 133 against the elastic force F1. It will be appreciated that the controller 177 can calculate the specific magnitude of the elastic force F1 currently applied by the resilient member 376 based on the positional information and known characteristics of the resilient member 376. The elastic force F1 of the resilient member 376 may also urge the movable body 171 to retract from, for example, the channel 133 back to initial position (e.g., in diffuser frame 131, which is not shown in the figures) when the electromagnetic driving execution assembly 175 is inactive, thereby possessing function of automatic reset.

In the embodiment shown in FIG. 4, the controller 177 controls, at least based on the position information, the electrical signal applied to the electromagnetic driving execution assembly 175 to enable the movable body 171 to tend to move in a target position in the channel 171, thereby causing the diffuser 13 to provide a predetermined diffusion capacity. If from the position information obtained from the feedback, it can be determined that the movable body 171 is in the target position, the electric signal is controlled to enable the magnetic field force F2 to be equal to the elastic force F1 so that the movable body 171 is stably held in the target position. If the movable body 171 deviates to the left with respect to the target position as seen from the position information obtained by feedback, the electric signal is controlled such that the magnetic field force F2 is greater than the elastic force F1, and if the movable body 171 deviates to the right with respect to the target position as seen from the position information obtained by feedback, the electric signal is controlled such that the magnetic field force F2 is less than the elastic force F1, until the movable body 171 is in the target position, thus a stable state is reached. Therefore, the movable body 171 can likewise be stably and reliably moved in a certain target position in the channel 133 by the electromagnetic actuating device.

It should be noted that when the movable body 171 is already in the target position, the controller 177 may determine from the feedback position information that the movable body 171 is already in the target position. Before an updating change of the target position occurs, in an embodiment, the electrical signal applied to the first electromagnetic driving execution assembly 175a may be controlled by the controller 177 to cause the magnetic field force F2 to be equal to the elastic force F1, thereby stabilizing the movable body 177 in the target position; in another alternative embodiment, the movable body 171 in the target position may also be fixed in the target position by means of mechanical limiting. As such, the movable body 171 can also be reliably fixed in a certain target position in the channel 133, facilitating to accurate and stable provision of a desired diffuser capacity.

Other identical configurations of the centrifugal compressor 30 as the centrifugal compressor 10 are not described in detail herein. It will be appreciated that the centrifugal compressor 30 may also basically achieve functions and effects of the centrifugal compressor 10.

The compressor 10 or 30 of the above embodiments may be a single stage compressor or a multi-stage compressor, which may be applied, for example, to the heat exchanger system of an embodiment of the disclosure. The heat exchanger system may include the compressor 10 or 30, and may also include an expansion valve, a condenser fluidly interposed between the compressor and the expansion valve, and a condenser fluidly interposed between the compressor and the expansion valve, and an evaporator or a cooler fluidly interposed between the expansion valve and the compressor. The compressor 10 or 30 is operable to compress saturated vapor therein and to output high-pressure and high-temperature superheated vapor towards the condenser. The condenser causes the superheated vapor received from the compressor 10 or 30 to condense through thermal transfer with water, for example. The heat exchanger system provided by the embodiments of the disclosure can be applied to various fields (such as the field of air-conditioning refrigeration).

Referring to FIG. 5, there is provided a method of operating the compressor 10 or 30 of any one of the above embodiments, wherein in step S510, the load condition of the centrifugal compressor 10 or 30 is determined.

In step S520, a target position of the movable body 171 in relation to the channel 133 is calculated; the target position may be determined according to the variable diffusion degree desired for the determined load condition, which can be a position that at least partially blocks the channel 133.

In step S530, the movable body 171 is driven to move towards the target position in an electromagnetic driving manner. For example, a force applied to the movable body by the electromagnetic actuating device is controlled by controlling electrical signal applied to the electromagnetic actuating device such that the movable body moves towards the target position, until the movable body 171 is stably and reliably located at the target position; as a result, the desired variable diffusion degree is achieved in the diffuser 13. The specific control principles in step S530 can be seen in the exemplary descriptions for the controller 177 shown in FIG. 2 or FIG. 4. The movable body 171 may be moved from its initial position (e.g., in the diffuser frame 131) towards current target position in the channel 133 and may be also moved from previous target position towards current target position in the channel 133.

The control operation for the movable body 171 in the operation method of the above embodiment is simple and is easy to implement.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A centrifugal compressor comprising:
an impeller for sucking a fluid to be compressed;
a diffuser disposed downstream of the impeller and having a respective diffuser frame, wherein the diffuser frame defines at least a channel through which the fluid flows from the impeller; and
a variable diffusion system;
characterized in that the variable diffusion system comprises:
a movable body that is able to move relative to the channel; and
an electromagnetic actuating device for controlling the movable body to move relative to the channel in an electromagnetic driving manner.

2. The centrifugal compressor according to claim 1, wherein the electromagnetic actuating device comprises:
an electromagnetic driving execution assembly for generating a controllable magnetic field to drive the movable body to move towards a target position at least partially blocking the channel;
a displacement transducer for sensing position information of the movable body relative to the channel; and
a controller;
wherein the position information is sensed and fed back to the controller by the displacement transducer, and the controller is configured for controlling an electric signal applied to the electromagnetic driving execution assembly at least on the basis of the position information.

3. The centrifugal compressor according to claim 2, wherein the electromagnetic actuating device further comprises:
a power amplifier for amplifying the control signal output by the controller so as to output the electric signal applied to the electromagnetic driving execution assembly.

4. The centrifugal compressor according to claim 2, wherein the electromagnetic driving execution assembly comprises a first electromagnetic driving execution assembly and a second electromagnetic driving execution assembly, and the first electromagnetic driving execution assembly and the second electromagnetic driving execution assembly are oppositely disposed on both sides of the movable body, respectively; and
wherein the controller controls, at least based on the position information, a first electric signal applied to the first electromagnetic driving execution assembly and a second electric signal applied to the second electromagnetic driving execution assembly, respectively, so as to enable the movable body to tend to move to the target position.

5. The centrifugal compressor according to claim 4, wherein the controller is further configured to, based on the position information, determine that movable body has been in the target position and control the electrical signal applied to the electromagnetic driving execution assembly to stabilize the movable body in the target position.

6. The centrifugal compressor according to claim 2, wherein the variable diffusion system further comprises a resilient member, and the resilient member and the electromagnetic driving execution assembly are oppositely disposed on both sides of the movable body, respectively; and
wherein one end of the resilient member acts on the movable body and applies an elastic force to the movable body, and the controller, at least based on the position information, controls the electric signal applied to the electromagnetic driving execution assembly to enable the movable body to overcome the elastic force and tend to move to the target position.

7. The centrifugal compressor according to claim 6, wherein the controller is further configured to, based on the position information, determine that movable body has been in the target position and control the electrical signal applied to the electromagnetic driving execution assembly to stabilize the movable body in the target position.

8. The centrifugal compressor according to claim 2, wherein the target position is determined by the controller in accordance with a load condition of the centrifugal compressor.

9. The centrifugal compressor according to claim 1, wherein the movable body comprises an annular magnetic member.

10. The centrifugal compressor according to claim 1, wherein the electromagnetic actuating device controls the movable body to move steplessly or stepwise relative to the channel in the electromagnetic driving manner to cause the diffuser to provide a steplessly or stepwise variable diffusion capacity.

11. A method of operating a centrifugal compressor comprising an impeller for sucking a fluid to be compressed, a diffuser disposed downstream of the impeller and having a respective diffuser frame, wherein the diffuser frame defines at least a channel through which the fluid flows from the impeller, and a variable diffusion system, wherein the variable diffusion system includes a movable body that is able to move relative to the channel and an electromagnetic actuating device for controlling the movable body to move relative to the channel in an electromagnetic driving manner, wherein the method comprises:
determining a load condition of the centrifugal compressor;
determining a target position of the movable body in the channel according to the load condition; and
controlling a force applied to the movable body by the electromagnetic actuating device by controlling electrical signal applied to the electromagnetic actuating device such that the movable body moves towards the target position;
wherein the target position is a position that at least partially blocks the channel.

12. The method of claim 11, wherein the electromagnetic actuating device comprises:
an electromagnetic driving execution assembly for generating a controllable magnetic field to drive the movable body to move towards a target position at least partially blocking the channel;
a displacement transducer for sensing position information of the movable body relative to the channel; and
a controller.

13. The method of claim 12, further comprising:
sensing the position information;
feeding back said position information to the controller by the displacement transducer;
controlling an electric signal applied to the electromagnetic driving execution assembly at least on the basis of the position information.

14. The method of claim 12, wherein the electromagnetic actuating device further comprises:
a power amplifier for amplifying the control signal output by the controller so as to output the electric signal applied to the electromagnetic driving execution assembly.

15. The method of claim 12, wherein the electromagnetic driving execution assembly comprises a first electromagnetic driving execution assembly and a second electromagnetic driving execution assembly, and the first electromagnetic driving execution assembly and the second electromagnetic driving execution assembly are oppositely disposed on both sides of the movable body, respectively, the method further comprising:
controlling, with the controller, at least based on the position information, a first electric signal applied to the first electromagnetic driving execution assembly and a second electric signal applied to the second electromagnetic driving execution assembly, respectively, so as to enable the movable body to tend to move to the target position.

16. The method of claim 15, further comprising, determining, with the controller, based on the position information, that movable body has been in the target position and control the electrical signal applied to the electromagnetic driving execution assembly to stabilize the movable body in the target position.

17. The method of claim 12, wherein the variable diffusion system further comprises a resilient member, and the resilient member and the electromagnetic driving execution assembly are oppositely disposed on both sides of the movable body, respectively, and wherein one end of the resilient member acts on the movable body and applies an elastic force to the movable body, the method further comprising:
controlling, with the controller, at least based on the position information, the electric signal applied to the electromagnetic driving execution assembly to enable the movable body to overcome the elastic force and tend to move to the target position.

18. The method of claim 17, further comprising, determining, with the controller, based on the position information, that movable body has been in the target position and control the electrical signal applied to the electromagnetic driving execution assembly to stabilize the movable body in the target position.

19. The method of claim 12, wherein the target position is determined by the controller in accordance with a load condition of the centrifugal compressor.

20. The method of claim 11, further comprising controlling, with the electromagnetic actuating device, the movable body to move steplessly or stepwise relative to the channel in the electromagnetic driving manner to cause the diffuser to provide a steplessly or stepwise variable diffusion capacity.
